(19) United States
(12) Patent Application Publication
(10) Pub. No.: US 2024/0103306 A1
(43) Pub. Date: Mar. 28, 2024

(54) DYNAMICALLY CONTROLLED EMISSIVITY AND METHODS THEREOF

(71) Applicant: UNM RAINFOREST INNOVATIONS, Albuquerque, NM (US)

(72) Inventors: Sang Eon HAN, Albuquerque, NM (US); Sang M. HAN, Albuquerque, NM (US); James GILCHRIST, Orefield, PA (US); Jinghui GAO, Bethlehem, PA (US); Samuel WILSON-WHITFORD, Leicester (GB)

(73) Assignee: UNM RAINFOREST INNOVATIONS, Albuquerque, NM (US)

(21) Appl. No.: 18/370,954

(22) Filed: Sep. 21, 2023

Related U.S. Application Data
(60) Provisional application No. 63/379,320, filed on Oct. 13, 2022.
(60) Provisional application No. 63/408,647, filed on Sep. 21, 2022.

(51) Int. Cl. G02F 1/09; G02F 1/01

(52) U.S. Cl. CPC G02F 1/094; G02F 1/0121

(57) ABSTRACT

Suspensions of magneto-responsive Janus colloids form chains and undergo alignment under the influence of a magnetic field. When the magnetic field is aligned with a light path, light transmission through the sample increases as compared to randomly or orthogonally oriented chains. The emissivity response of this suspension is presented as a function of particle concentration and magnetic field strength. A variation of the Beer-Lambert model and ray-tracing simulations capture the behavior of the experimentally measured difference in intensity between magnetically activated and non-activated Brownian suspensions. Experiments demonstrate up to 25% contrast in transmission of visible light, which may be further optimized through materials selection. Similar experiments when these Janus particle chains are suspended in carbon tetrachloride, demonstrate an emissivity variation in the near infrared of ˜10%.

### REFERENCE TO RELATED APPLICATIONS

This application claims the benefit of U.S. Provisional Patent Application No. 63/408,647 filed Sep. 21, 2022 and 63/379,320, filed on Oct. 13, 2022, which are hereby incorporated by reference in their entirety.

### STATEMENT OF GOVERNMENT INTEREST

This invention was made with government support under W56KGY-19-D-0001 (AR60) awarded by the Department of Defense (Army). The government has certain rights in the invention.

### TECHNICAL FIELD

The present teachings relate generally to magneto-responsive Janus particles and, more particularly, to the dynamic emissivity of self-assembled magneto-responsive Janus particle chain suspensions.

### BACKGROUND

Under the influence of a magnetic field, Janus particles having iron caps will assemble into linear chains of rod-like particles and the magnetic field can then be used to dynamically reorient these rods. Suspensions of rod-shaped particles having large aspect ratios have rheology that causes jamming in confined geometries such as microcapsules and narrow fluidic pathways. By suspending individual particles, they can be handled as low-viscosity suspensions and then assembled into rods where they are to be used in various applications.

The difficulties in fabrication of Janus particles having uniform properties have plagued their incorporation into products beyond the laboratory. Janus particles synthesized by microfluidic combination of two materials in a laminar flow have significant limitations. The particle size is dictated by capillary forces, and the library of compatible materials is also limited. The scalability of this process, with one-by-one particle generation, is also suboptimal. Several other synthetic routes are potentially scalable, such as wax emulsions and nanoprecipitation; however, these have limits with both materials selection and result in Janus particles having significant polydispersity in cap uniformity due to contact line hysteresis. Janus particles are commonly created by coating monolayers of colloidal particles on a surface and deposit a metal using physical vapor deposition (PVD), allowing for a wide range of material options. The challenges of creating large-area coatings mean coating this way typically results in limited quantities.

Therefore, it is desirable to fabricate Janus particles in a range of particles sizes in large quantities to form suspensions of magnetically responsive solutions or suspensions.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later. An optical device is disclosed. The optical device includes a substrate. The device also includes a plurality of particles disposed in a layer on the substrate, where each of the plurality of particles may include at least two surface characteristics, where the at least two surface characteristics each have distinct physical properties from one another. The device also includes a cover disposed over the plurality of particles. The device also includes an electromagnetically actuated field in proximity to the layer of the plurality of particles. Implementations may include where the optical device where the substrate reflects in an infrared range. The substrate may include a transparent material. The substrate further may include a reservoir. The plurality of particles is suspended in a transparent fluid. The fluid may include carbon tetrachloride, chloroform, water, isopropyl alcohol, or a combination thereof. A concentration of the plurality of particles in the transparent fluid is a volume fraction from about 0.1 to about 1.5. The plurality of particles further may include silica, polystyrene, polymethyl methacrylate, or a combination thereof. The plurality of particles is from about 100 nm to about 50 microns. The plurality of particles further may include a ferromagnetic coating on a portion of the surface of each of the plurality of particles. The ferromagnetic coating has a thickness of from about 25 nm to about 150 nm. The detector may include a charge-coupled device (CCD) camera detector, a photospectrometer, a pryoelectric detector, or a combination thereof. The cover further may include an infrared transparent material. The electromagnetically actuated field is generated by a magnet, a Helmholtz coil, or a combination thereof.

Another optical device is disclosed. The optical device includes a substrate which can include a reservoir. The optical device also includes a suspension of a plurality of particles in an infrared transparent fluid, may include a ferromagnetic coating on a portion of a surface of each of the plurality of particles, where the suspension is disposed in a layer on the substrate. The optical device also includes an infrared transparent cover disposed over the plurality of particles. The optical device also includes an electromagnetically actuated field in proximity to the layer of the plurality of particles. The device also includes a detector in proximity to the cover to measure emissivity. Implementations may include where the plurality of particles further may include silica, the infrared transparent fluid may include isopropanol, and the plurality of particles in the infrared transparent fluid is a volume fraction from about 0.1 to about 1.5. Implementations of the described techniques may include hardware, a method or process, or computer software on a computer-accessible medium.

A method to control emissivity is disclosed. The method to control emissivity includes applying an electromagnetically actuated field to an optical device having a plurality of particles, where each of the particles may include at least two surface characteristics, one of which is ferromagnetic, controlling alignment of the plurality of particles depending upon the applied electromagnetically actuated field, and measuring emissivity reflected by the device with a pyroelectric detector. Implementations may include where the emissivity reflected by the device is decreased when the plurality of particles are aligned. Measuring emissivity further may include measuring total reflectance. In examples, the plurality of particles further may include silica, polystyrene, polymethyl methacrylate, or a combination thereof; and the plurality of particles are suspended in an infrared transparent fluid, and the infrared transparent fluid may include carbon tetrachloride, chloroform, water, isopropyl alcohol, or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A-1D are a schematic configuration of a device for variable IR emissivity, a schematic of a single Janus particle made of a SiO2 core coated with Fe, with magnetic poles shown, an orientation of chains of assembled in a variable magnetic field and their relative orientation and projected area as a function of field angle, θ, and an optical image of a single chain of Janus particles, respectively, in accordance with the present disclosure.

FIG. 2 depicts a schematic of a sample device used in for variable IR emissivity, in accordance with the present teachings.

FIG. 3 is a plot depicting IR emissivity spectra of the device of FIG. 2 when a magnetic field was on and off, in accordance with the present disclosure.

FIG. 4 is a plot depicting the difference between the measured light transmittance of Janus particle solutions with an activated Helmholtz coil aligning the primary axis of the chains with the direction of light and the solution without the magnetic field, in accordance with the present disclosure.

FIGS. 5A-5C are plots depicting model results from the adaptation of the Beer-Lambert Law, and measurements of light transmittance through Janus particle suspensions with variable concentration and magnetic strength, respectively, in accordance with the present disclosure.

FIGS. 6A and 6B are plots depicting intensity as a function of orientation angle and maximum intensity at θ=0 plotted as a function of field strength matches the functional form predicted in equation (5) confirming the influence of thermal noise on effective chain length. β=μ₀·H, in accordance with the present disclosure.

FIG. 7 is a depiction of ray-tracing simulation results of a system of chains of either 3 or 6 beads. The inset figures show a rendered image of the simulated particle chains for actuated (left) and randomly oriented unactuated (right) suspensions, in accordance with the present disclosure.

FIG. 8 is a plot depicting an intensity difference with variable concentration, measured at different angles as compared to randomly oriented particles, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present teachings provide an optical device, that includes a reflective substrate, a plurality of particles each particle comprising at least two surface characteristics, wherein the at least two surface characteristics each have distinct physical properties from one another, disposed in a layer on the reflective substrate, a cover disposed over the plurality of particles, and an electromagnetically actuated field in proximity to the layer of the plurality of particles. Such optical devices in some examples can include an infrared reflective or a transparent substrate comprising a reservoir, a suspension of a plurality of particles in an infrared transparent fluid, comprising a ferromagnetic coating on a portion of a surface of each of the plurality of particles, disposed in a layer on the infrared reflective substrate, an infrared transparent cover disposed over the plurality of particles, an electromagnetically actuated field in proximity to the layer of the plurality of particles, and a detector in proximity to the cover to measure emissivity. In examples, the plurality of particles further includes silica, and the infrared transparent fluid includes isopropanol. Methods for controlling emissivity can include applying an electromagnetically actuated field to an optical device having such a plurality of particles, wherein each of the particles comprise at least two surface characteristics, one of which is ferromagnetic, controlling alignment of the plurality of particles depending upon the applied electromagnetically actuated field, and measuring emissivity reflected by the device with a pyroelectric detector.

Thermal infrared (IR) emissivity of a surface can be dynamically controlled by using magnetic Janus particles. Janus particles are special types of nanoparticles or microparticles whose surfaces have two or more distinct physical properties. In embodiments described herein, a plurality of particles with each particle having at least two surface characteristics, wherein the at least two surface characteristics each have distinct physical properties from one another may be used.

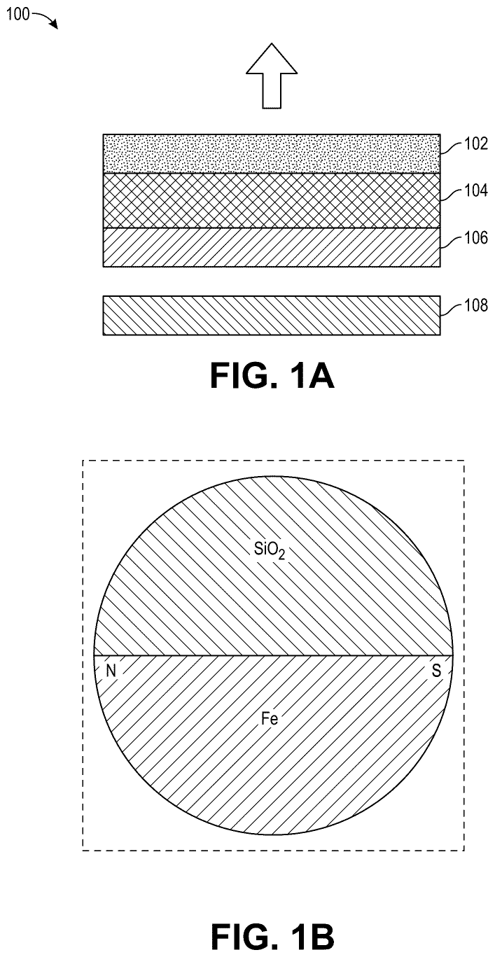

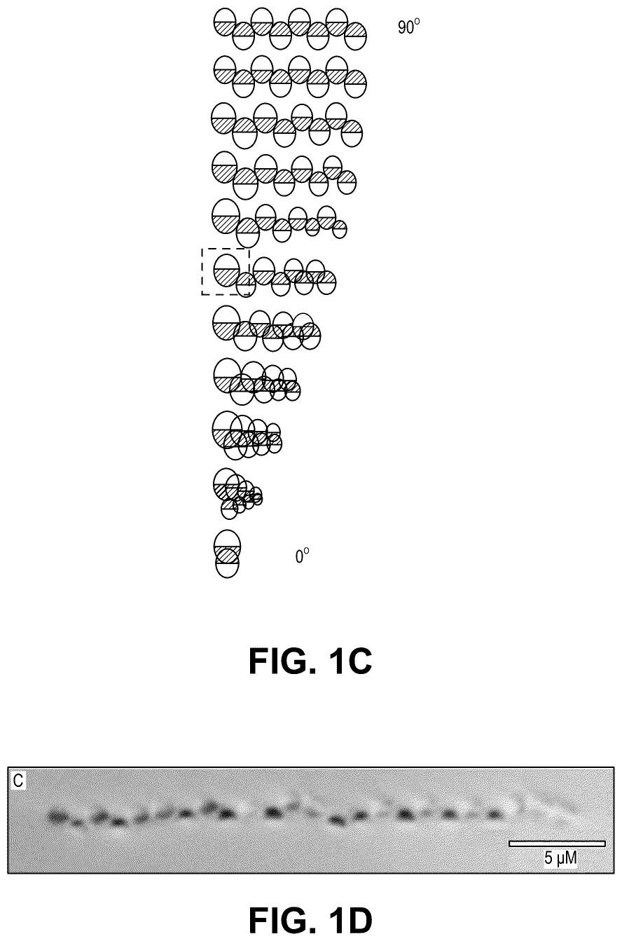

FIGS. 1A-1D are a schematic configuration of a device for variable IR emissivity, a schematic of a single Janus particle made of a SiO₂ core coated with Fe, with magnetic poles shown, an orientation of chains of assembled in a variable magnetic field and their relative orientation and projected area as a function of field angle, θ, and an optical image of a single chain of Janus particles, respectively, in accordance with the present disclosure.

FIG. 1A is a schematic configuration of a device for variable IR emissivity. Within the optical device 100 is a responsive layer 104 including colloids of a plurality of Janus particles in an IR-transparent liquid which can be sandwiched between an IR-transparent cover layer 102 and an IR-reflective metal layer or other reflective substrate 106, wherein the substrate may reflect in the infrared or other spectral range. In certain examples, the substrate may be a transparent material, transparent in any spectral range of interest or activity by one or more of the components in the device 100. When a magnetic field in proximity of the optical device is applied to the system, with, for example, the use of a magnet 108, Janus particles in the responsive layer 104 can self-align and decrease emissivity of the responsive layer 104. In certain examples, there may be no source of refraction or interference between the layer 104 including the plurality of Janus particles and the cover layer 102.

Additional non-limiting examples of aspects of the device of the present teachings is described herein. The range of particles that have been explored are 1 micron to 50 microns in diameter. Particles as small as 50 nm can be functionalized using the methods herein. The materials tested were SiO₂ (silica), polystyrene (PS), polymethyl methacrylate (PMMA). Certain exemplary methods disclosed herein were not sensitive to the particle chemistry. Functional coatings can be produced with a procedure including where a monolayer of particles is coated on the exposed hemisphere with either iron or nickel using physical vapor deposition (PVD). The process results in iron and oxides of iron as the magnetic material. In alternate examples, chemical vapor deposition (CVD), or other solution-based coating methods can be employed. Any metal that results in a ferromagnetic or paramagnetic response may be used. The particles are then removed via physical abrasion and sonication into the suspending fluid. This geometry, a particle with half of its surface having a different chemistry, is commonly known as a Janus particle. Either of the materials associated with the particle must reflect, refract, or absorb the wavelengths of interest.

Essentially any optically clear fluid where the particles are originally stabilized through their electrostatic or steric interactions can be used in the devices as described herein. For the visible spectrum, water and isopropanol can be used and for infrared (IR) use, chloroform and carbon tetra chloride can be used for the suspending medium. The fluid should allow transmission of the wavelengths of interest. The actuation of particles can be chosen or employed based on the particles and the response to either the physical manipulation of a permanent magnetic field of a bar magnet or an electromagnetically actuated field, such as the uniform magnetic field produced by a Helmholtz coil. Upon exposure to the magnetic field, two responses are observed. The first is to bring individual or small aggregates of particles into alignment as chains. The geometric structure of these chains is one that aligns the magnetic cap materials that create a zigzag chain. The exact configuration of these chains does not have a strong impact on the performance. Chains can be observed through both optical microscopy of individual chains and using laser light scattering. The second response is the alignment of these chains with the magnetic field. Chain alignment can also be observed directly through optical microscopy and through laser light scattering (FIG. 1D).

Optical testing can be conducted by placing a suspension of Janus particles held in a clear vial at a known concentration, reported as volume fraction as calculated from weight measurements of suspension, and a backlight is illuminated such to pass light through the sample. A CCD camera is used in combination with photospectrometer measurements of benchmark samples to accurately determine the degree of light transmittance. Using measurements of a photospectrometer, the performance of these materials is relatively constant across the narrow range of the visible spectrum. The results below are 1 micron SiO₂ microspheres functionalized with 50 nm of Fe in isopropanol tested in a Helmholtz coil after being exposed to a strong magnetic field to assemble the particles into chains.

Janus particles in solution can be exposed to various strengths of magnetic field at different concentrations. For example, the solution can be introduced into the center of a Helmholtz coil and the intensity without the field on can be measured and then the response of the light intensity can be measured upon actuation of the magnetic field. Thus, the intensity difference or contrast change is measured between the random orientations of the Janus particles as compared to the alignment of Janus particle chains in the direction of the light path.

At the limit of no particles, there will be no contrast change before or during actuation. In the limit of very high concentration, no light will be transmitted and thus no contrast change. Thus, there is an optimal concentration where there is a maximum intensity difference. This is true for all measured magnetic strengths ranging from 0.05 mT to 2 mT. The low concentration range of each curve roughly approximates the Beer-Lambert Law of linear light absorbance through a suspension, with the change of effective particle emissivity or an effective fractional concentration as a function of angle. At higher concentrations, the peak of this maximum intensity difference shifts to the right apparently due to the formation of larger chains and the higher alignment of these chains with the path light in opposition to thermal noise. Upon release of the field, the system quickly recovers to a random configuration of chains due to thermal noise. The response rate is fast, on the order of milliseconds or faster, and is a function of the size of the Janus particles and the length of the chains.

Advantages of the present teachings include dynamic assembly, a broad range of optical response, and fast dynamic response. One of the advantages of this system over others is the ability to assemble these chains of Janus particles in situ and manipulate their orientation. Other rod-like and plate-like colloids have been reported in previous works to give weak contrast in light transmittance. These materials present challenges when processing these materials into confining geometries such as droplets or thin films. Because of the wide range of both materials and sizes that can be employed in the present teachings, the optical response of devices of the present disclosure can be tuned to have a tailored response to various ranges of wavelengths. Finally, the response of these particles allows optical contrast changes on the order of milliseconds.

Janus particles can be defined as amphiphilic particles having two different physical and/or chemical attributes on different hemispheres. Since their first description, their use in manipulating light has been envisioned with regard to design of digital displays of physically rotating single particles in electric or magnetic fields. This approach primarily depends on the reflection and scattering of light manipulated by the exposure of the two different faces of the particle and often requires a significant effort in designing the field as is done in e-ink displays that migrate two different colored dispersed particles in an electrode stack. Prior studies have also considered single particles in suspension whose orientation alters the apparent suspension optical signature through reflected or transmitted light with limited apparent contrast.

Under the influence of a magnetic field, micron-scale Janus particles having iron caps can assemble into linear chains of rod-like particles and the magnetic field can then be used to dynamically reorient these rods, as shown in FIGS. 1B-1D. There is a distinct advantage to this approach. Suspensions of rod-shaped particles having large aspect ratio have rheology that causes jamming in confined geometries such as microcapsules and narrow fluidic pathways. By suspending individual particles, they can be handled as low viscosity suspensions and then assembled into rods where they are to be used in application. Likewise, the nature of these Janus particle rod-like assemblies is that they will generally have less flexibility than core-shell particles because of the proximal surface contact on the outer side of the Janus particle. Because they form zipper like structures, they are mechanically stable as compared to linear chains of particles. Chain aggregation of simple magnetic particle suspensions has long been studied as a magnetorheological fluid. These fluids form sample spanning aggregates that cannot be easily manipulated to have variable orientation. Light transmission through these samples has been used to demonstrate their irreversible aggregation kinetics. Single chain orientations have been studied as model polymer systems. Rod-shaped Janus particle chains have been characterized previously and their orientation has a north-south dipole oriented in the direction of the major axis of the chain.

The difficulties in fabrication of Janus particles having uniform properties have, in the past, been difficult to incorporate into devices or products beyond the laboratory scale. Janus particles synthesized by microfluidic combination of two materials in a laminar flow have significant limitations. Particle size is dictated by capillary forces and the library of compatible materials is also limited. The scalability of this process, with one-by-one particle generation, is also sub-optimal. Several other synthetic routes are potentially scalable, such as wax emulsions and nanoprecipitation, however these have limits with both materials selection and result in Janus particles having significant polydispersity in cap uniformity due to contact line hysteresis. Janus particles are commonly created by coating monolayers of colloidal particles on a surface and deposit a metal using physical vapor deposition (PVD), allowing for a wide range of material options. The challenges of creating large area coatings means coating this way typically results in limited quantities. A continuous roll-to-roll monolayer coating of particles using Automated Langmuir-Blodgett (ALB) deposition approach, demonstrated for diameters ranging 50 nm to 50 μm, synthesizes 1 μm SiO₂—Fe Janus particles in quantities that easily produces in liter-scale suspensions of magnetically-responsive solution used in the present teachings. As further shown in FIG. 1B, a schematic of a Janus particle made of a SiO₂ core coated with Fe is shown with magnetic poles indicated. In FIG. 1C, the orientation of chains of assembled in a variable magnetic field and their relative orientation and projected area as a function of field angle, θ, is shown. Finally, in FIG. 1D, an optical image of a single chain of Janus particles is depicted.

Examples of an optical device consistent with the present teachings include a reflective substrate, a plurality of particles each particle comprising at least two surface characteristics, wherein the at least two surface characteristics each have distinct physical properties from one another, disposed in a layer on the reflective substrate, a cover disposed over the plurality of particles, and an electromagnetically actuated field in proximity to the layer of the plurality of particles. In some examples, the reflective substrate reflects in the infrared range, and can be gold. In other examples, the reflective substrate further includes a reservoir. In examples, the plurality of particles is suspended in a transparent fluid, which can be but is not limited to carbon tetrachloride, chloroform, water, isopropyl alcohol, or a combination thereof. The plurality of particles can include but is not limited to silica, polystyrene, polymethyl methacrylate, or a combination thereof. The concentration of the plurality of particles in the transparent fluid is a volume fraction from about 0.1 to about 1.5, and the plurality of particles can have a size from about 1 micron to about 50 microns, or from about 100 nm to about 250 nm. In examples, the plurality of particles further incorporates a ferromagnetic coating on a portion of the surface of each of the plurality of particles, which can have a coating thickness of from about 25 nm to about 150 nm. The optical device can include a detector configured to measure radiation emitted through the cover, such as a charge-coupled device (CCD) camera detector, a photospectrometer, or a pryoelectric detector. During measurement, there is no source of refraction between the plurality of particles and the cover. The cover of the optical device can further an infrared transparent material. The electromagnetically actuated field of the optical device can be generated by a magnet, or by a Helmholtz coil.

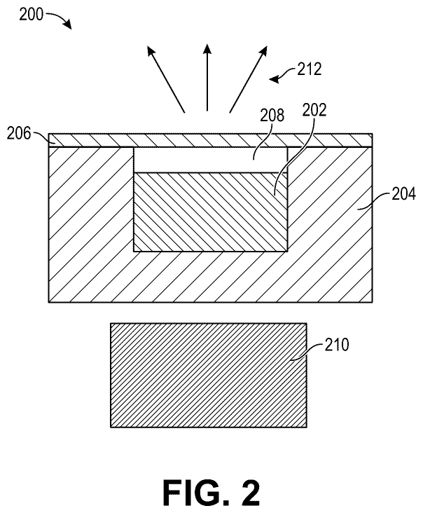

FIG. 2 depicts a schematic of a sample device used in for variable IR emissivity, in accordance with the present teachings. To further evaluate the concept, a device 200 was fabricated using a colloid of magnetic Janus particles 202 was placed in a gold dish 204 including a reservoir for holding the colloid of magnetic Janus particles 202 and covered over the top with a transparent polyethylene film 206 as shown in FIG. 2. An air gap 208 is shown between the surface of the colloid of magnetic Janus particles 202 and the transparent polyethylene film 206, although other inert gases may also be used in this capacity. The substrate has a reservoir or well for holding the colloid, particles, or fluid. The particles used are silica spheres of 1 mm in diameter and a half side of each of the spheres was coated with ferromagnetic iron (Fe) at a thickness of 100 nm. The particles were suspended in carbon tetrachloride (CCl₄). A magnetic field was applied from the bottom using a ferromagnet 210. Emissivity 212 of the device was obtained by measuring total reflectance, which includes both specular and diffuse light components. Light scattered by the sample was collected by a gold-coated integrating sphere and measured by a DLaTGS pyroelectric detector. The detector may be configured to measure radiation emitted from the device.

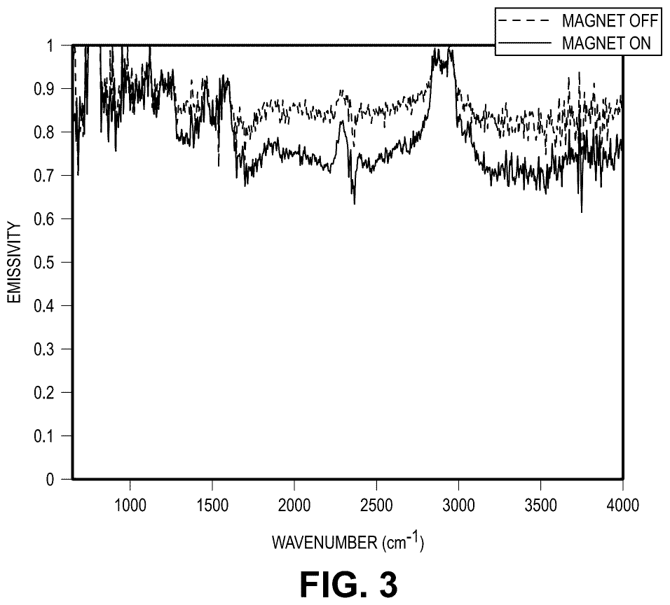

FIG. 3 is a plot depicting IR emissivity spectra of the device of FIG. 2 when a magnetic field was on and off, in accordance with the present disclosure. FIG. 3 shows that emissivity of the device decreases when a magnetic field is applied. Optimized design of the device would increase the emissivity difference between on and off states of magnetic field. In the optimization, design parameters would include IR-transparency window of the liquid, thickness of the liquid, magnetic orientation and strength, concentration of the Janus particles, particle sizes, composition of the particles, IR-transparent cover material, and so on. It is further understood that suspensions of directionally manipulatable particle chains could be used to dynamically control infrared emissivity. To assess the usefulness of this approach, Janus particles were suspended in carbon tetrachloride (CCl₄). FIG. 3 compares the measured emissivity between magnetic field on and off, demonstrating that near-infrared emissivity can be varied by ˜0.1. The saturation of emissivity in 2830-2980 cm⁻¹ is due to strong absorption in the polyethylene film. Because absorption by CCl₄ is strong at the solution depth in our experiment, it is expected that the emissivity difference would be amplified at a smaller depth with a higher Janus particle concentration where absorption is primarily due to the particles. For dynamic control of thermal infrared emissivity at moderate temperatures, a solvent with a low absorption coefficient at thermal wavelengths, such as carbon disulfide, can be used.

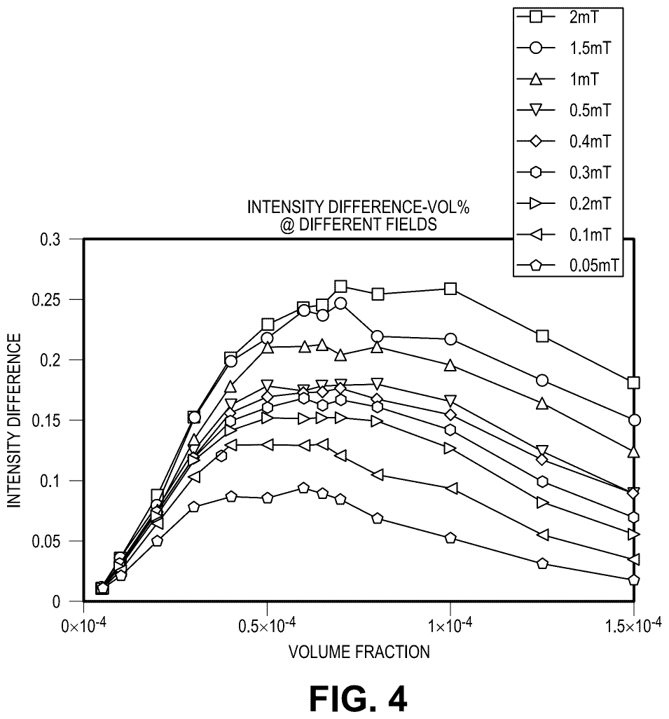

FIG. 4 is a plot depicting the difference between the measured light transmittance of Janus particle solutions with an activated Helmholtz coil aligning the primary axis of the chains with the direction of light and the solution without the magnetic field. Janus particles in solution are exposed to various strengths of magnetic field at different concentrations. The solution is introduced into the center of the Helmholtz coil and the intensity without the field on is measured and then the response of the light intensity is measured upon actuation of the magnetic field. Thus, the intensity difference or contrast change is measured between the random orientations of the Janus particles as compared to the alignment of Janus particle chains in the direction of the light path.

In the limit of no particles, there will be no contrast change. In the limit of very high concentration, no light will be transmitted and thus no contrast change. Thus, there is an optimal concentration where there is a maximum intensity difference. This is true for all measured magnetic strengths ranging from 0.05 mT to 2 mT. The low concentration range of each curve roughly approximates the Beer-Lambert Law of linear light absorbance through a suspension, with the change of effective particle emissivity or an effective fractional concentration as a function of angle. At higher concentrations, the peak of this maximum intensity difference shifts to the right apparently due to the formation of larger chains and the higher alignment of these chains with the path light in opposition to thermal noise. Upon release of the field, the system quickly recovers to a random configuration of chains due to thermal noise. The response rate is fast, on the order of milliseconds or faster, and is a function of the size of the Janus particles and the length of the chains. Furthermore, visual confirmation of the Janus particle chains and the scattering pattern confirms their orientation response to the magnetic field. Dynamic response profiles showing the rate of response of transmittance to the activation of the magnetic field have also been measured. A model has been developed adopting the Beer-Lambert equation to support observed behavior of the Janus particles. Simple raytracing simulations have also been conducted, confirming the primary mechanism related to the two orientations.

To probe the variable emissivity of this solution, the magnetically-responsive orientation of Janus particle chains in suspension can be manipulated relative to the direction of light transmittance. For suspensions of spherical, non-oriented particles, the Beer-Lambert Law is the linear approximation of the light decay as a function of concentration in dilute suspensions. This relationship is modified to consider chain orientation, where

$$\frac{I ( θ )}{{I}_{0}} = {e}^{- ε ( θ ) {ε}_{0} l c} \qquad ( 1 )$$

Here,

$$\frac{I}{{I}_{0}}$$

is the relative light intensity passing through a suspension having concentration, c, pathlength l, and an absorption coefficient for a single sphere, co. An angle dependent dimensionless absorption coefficient, ε(θ), is introduced to model the orientation of the chains, shown in FIG. 1b where light hits the chain end on for θ=0°. The geometric projection of this chain onto the direction of light transmittance is

ε(θ)≈1+|(n−1)·sin(θ)| (2)
where n is the number of particles in the chain. For simplicity, this approximation assumes a perfect chain of identical, symmetric particles. The primary metric of performance can be the difference between the “on” and “off” states between θ=90° and θ=0°,

$$\frac{Δ I ( 0 , \frac{π}{2} )}{{I}_{0}} = \frac{I ( 0 ) - I ( \frac{π}{2} )}{{I}_{0}} = {e}^{- {ε}_{0} l c} - {e}^{- n {ε}_{0} l c} \qquad ( 3 )$$

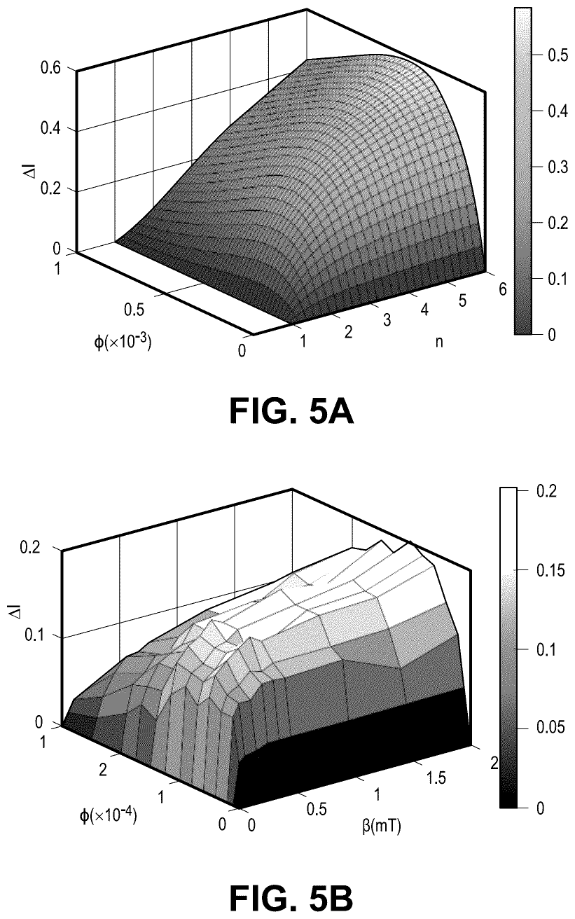

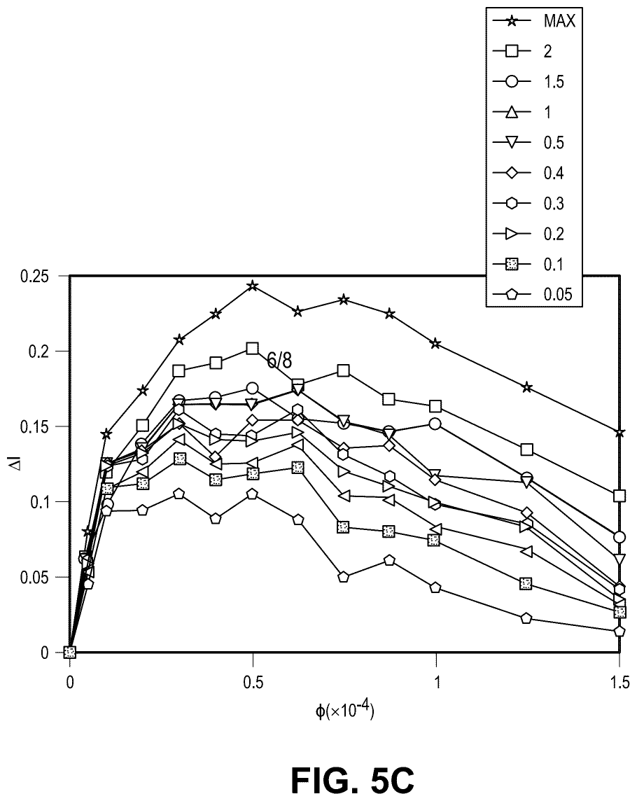

The resulting contrast in emissivity are considered at an arbitrary value of Ea, which is material and system dependent and not optimized for this study. FIGS. 5A-5B are plots depicting model results from the adaptation of the Beer-Lambert Law, and measurements of light transmittance through Janus particle suspensions with variable concentration and magnetic strength, respectively, in accordance with the present disclosure. Light transmittance is measured through Janus particle suspensions at various concentrations with and without an applied magnetic field imparted by a Helmholtz coil, as shown in FIGS. 5B and 5C. As shown in FIG. 5A, the result of this model gives two common sense limits of expected performance where at c=0 there is no decay in intensity and for large concentrations essentially no light is let through. This gives low and high concentration limits of

$$Δ \frac{I}{{I}_{0}} = 0 .$$

Between these limits, the maximum intensity difference increases monotonically with an increase in chain length. A chain length of n=1 has no intensity difference reported, though the Janus particle orientation may result in some minor degree of contrast in these dilute concentrations, as reported previously.

The intensity difference in the model is the aligned Janus particles in the direction of the light path as compared to orthogonally oriented Janus particle chains. The experimental results compared aligned Janus particle chains as compared to randomly oriented chains when the field is removed. The magnetic moment is aligned in the direction of the illumination. These Janus particle suspensions are first subjected to a 0.5 T permanent magnet for an extended amount of time to form the initial chains prior to manipulation with the Helmholtz. In this limit, the chains are longer than what would form in a reasonable amount of time at the weaker magnetic field strengths used to manipulate their orientation. In suspension, they are relatively dilute and do not have significant transients after formation besides the effects of sedimentation. The sample is resuspended prior to each measurement and measurements are taken quickly in less than a minute as to reduce the impact of sedimentation. The same general functional form of intensity difference was found in these experiments. At the lowest concentrations, the linear model of light absorption fits the data well while at higher concentrations the profile deviates from this ideal case, likely from multiparticle scattering and chain-chain interactions. The shift in maximum intensity difference to slightly higher concentrations is captured by both the model and experiments.

The magnitude of the intensity difference measured in experiments and predicted by theory are not expected to match since the theory lacks accurate material parameters. A fit to the experimental data, however, suggests the effective chain length is n≈3 particles. This result is much lower than the chain lengths n>10 particles determined by optical microscopy. This deviation could result from imperfect materials scattering light and chains that are not perfectly linear. However, one can consider that the chain is held in place against thermal motion. This impact can be predicted by a model of the angular distribution of chains. A Boltzmann distribution of orientations is

p(θ)dθ=exp(AH·cos θ)sin θdθ (4)

Therefore, the absorbance is a function of magnetic field H. The applied magnetic field is assumed to be relatively large such that the majority of θ is close to zero,

$$〈 ε ( θ ) 〉 := \frac{{\int }_{2}^{π} ε ( θ ) p ( θ ) d θ}{{\int }_{2}^{π} p ( θ ) d θ} = 1 + \frac{{A}^{′}}{\sqrt{H}} \qquad ( 5 )$$

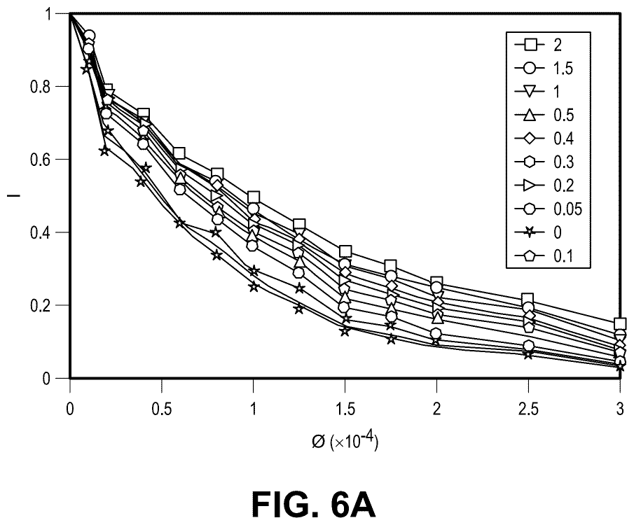

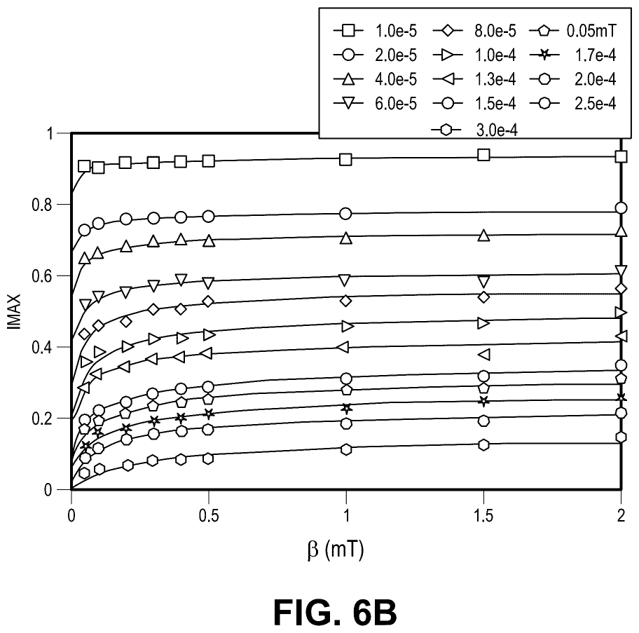

A′ is a constant here. FIGS. 6A and 6B are plots depicting measured intensity as a function of orientation angle and maximum intensity at θ=0 plotted as a function of field strength (in mT) matches the functional form predicted in equation (5) confirming the influence of thermal noise on effective chain length. β=μ₀·H, in accordance with the present disclosure. By fitting each set of data, the saturation state as a result of extrapolation can be plotted and predicted in FIG. 6B, as measured from light transmission experiments.

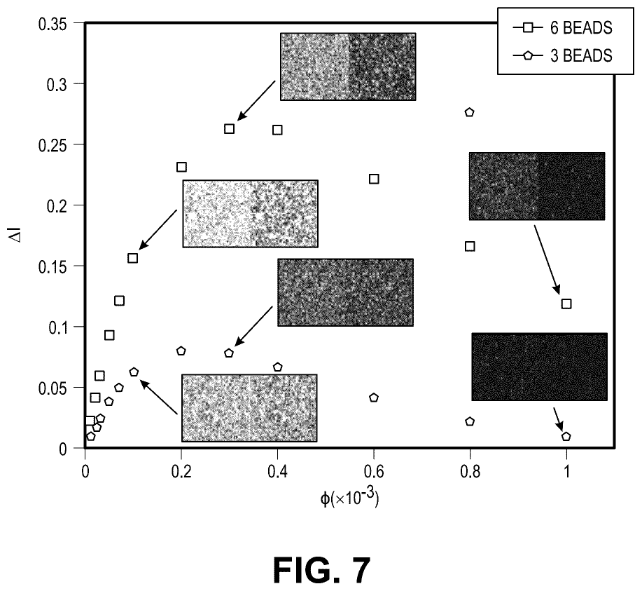

FIG. 7 is a depiction of ray-tracing simulation results of a system of chains of either 3 or 6 beads. The inset figures show a rendered image of the simulated particle chains for actuated (left) and randomly oriented unactuated (right) suspensions, in accordance with the present disclosure. To confirm these results from both theory and experiments, simple raytracing numerical computations can be performed with a fixed volume of randomly distributed Janus particle chains whose orientation were prescribed to be either oriented in the light path or in random orientations, as shown in FIG. 7. This results in the same functional form of the light intensity difference given by eq. (3). It should be noted that these predictions use classical macroscale physics that likely do not reflect the behavior of colloidal-scale particles from the experiments because the Janus particles are roughly the wavelength of the photons with which they are interacting. However, because the highest order effect is the size of the chains, it is reasonable to expect that more detailed modeling will yield similar results.

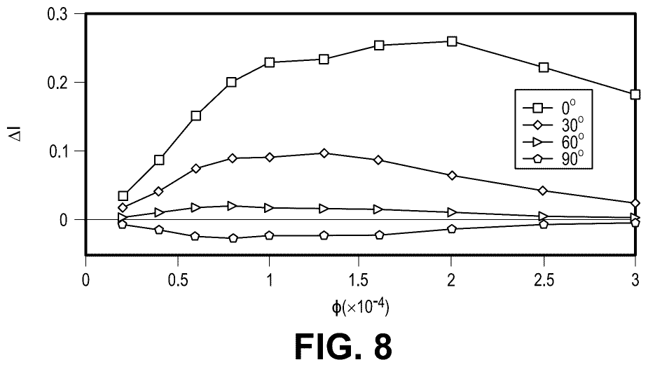

FIG. 8 is a plot depicting an intensity difference with variable concentration, measured at different angles as compared to randomly oriented particles, in accordance with the present disclosure. The measurements described herein are highly direction sensitive and have been measured at non-parallel angles, as depicted in FIG. 8. To demonstrate this, the Helmholtz coils were rotated 30°, 60°, and 90° to the light source and the transmittance was measured. From 0° to 30°, a sharp decay in transmitted light was observed and at 90°, the amount of light passing through the sample is slightly less than the random chain orientations. This does not contradict the assumptions about the orientation of particles and how light is transmitted as described by the original model, though for experiments and numerical results highlighted in FIGS. 5B, 5C, and 7 use the randomly oriented chains as a baseline. This suggests that little is to be gained by actuating the chain orientation in two orthogonal directions as compared to actuating the chains in the direction of the light path and then allowing thermal motion to relax the system to a randomly oriented system. The dynamics of the motion of actuation and their relaxation in Newtonian and non-Newtonian fluids is the topic of ongoing research.

The present teachings demonstrate an approach to creating magnetically-responsive variable emissivity suspensions from magnetically-assembled Janus particle chains. Simple theoretical model, the primary physics are captured using a simple theoretical model and ray-tracing simulations. The deviation of the model from theory resides in the thermal fluctuations, as predicted by a Boltzmann distribution of orientations near the aligned orientation. Demonstration of this effect is robust and works into the infrared for possible applications where radiative heat can be controlled by magnetically manipulating these suspensions. The response of these systems is on the order of milliseconds, enabling fast manipulation of light and/or radiative heat. It is noted that besides the choice of fluid for infrared measurements, none of the materials were chosen as optimization of this effect, and further particle functionalization could result in stronger differences in emissivity. Finally, the choice of using self-assembled chains from primary Janus particles allows for a more robust incorporation of these fluids with limited concerns of non-Newtonian behavior of these dilute suspensions.

Methods for particle functionalization include where silica particles having 1 micron diameter are assembled onto a 2D PVC film via a technique called Automated Langmuir-Blodgett (ALB). ALB is a continuous version of the well-known Langmuir-Blodgett method, a method of making uniform coating on a substrate by transferring the species, usually surfactants or particles, from air-liquid interface to air-solid interface in a Langmuir trough. ALB significantly enhances the production of 2D crystals compared to traditional methods like convective deposition. The second step is to deposit a metal layer onto the 2D crystal of silica particles by physical vapor deposition (PVD) operated in vacuum. Unless otherwise stated, a thickness of 50 nm of Fe is deposited. Undoubtedly, Fe partially oxidizes in air and in solution.

The suspensions of Janus particles are prepared with a sample from the roll of functionalized particles being soaked in ethanol with bath sonication for particle removal. This dilute suspension is concentrated with a strong magnet. Concentrated ethanol suspensions of Vol %=7.47E-4 are prepared, and the other samples are prepared by diluting the concentrated suspension with ethanol. Next, 1.5 mL of suspension is transferred to a disposable cuvette having a 10 mm width and sealed with parafilm to prevent evaporation.

For magnetic manipulation, each sample is exposed to a strong bar magnet (up to 500 mT at the surface of its pole) for at least 5 min before 20 s bath sonication to redisperse the suspension. Up to 150 s of experiments are done before the sample returns to be near the strong magnet. The magnetic field is generated by a pair of Helmholtz coils controlled by a relay. A power supply driving the control circuit provides a tunable output. The magnetic field is measured with a Hall effect gaussmeter. There is a minimal threshold of magnetic flux density we can measure, and it is 0.1 mT. Smaller ones are a result of the extrapolation of the applied current. All actuations follow an on/off pattern which is a periodic on-off cycle (1s on then 5s off, sometimes denoted as Relay15 or 1,5). Earlier experiments have shown that the system needs longer to relax. The sequence is controlled by a relay which is modulated by a Raspberry Pi 4 using Python 3 scripts.

Transmittance detection is conducted with the used of videos taken at 29.97 fps at 720p (1280*720 pixels) with a Canon EOS Rebel T7i DSLR or at 60 fps at 1080p (1920*1080 pixels) with a Chronos 2.1-HD High Speed Camera in monochrome mode. The entire setup is always fixed onto a Newport Optical Breadboard Plate with holders and screws. An LCD monitor displaying a white background is used.

For emissivity measurements, the Janus particles were suspended in carbon tetrachloride (CCl₄) at a volume fraction of ˜2×10⁻³. The colloidal solution was added into a disk-shaped sample vessel (see diagram in the Supplementary Information), where the fluid depth was ˜1 mm. Magnetic field was applied using a ferromagnet on the gold plate with field alignment, θ=0°. Normal emissivity of the sample was determined using a gold-coated integrating sphere in a spectrophotometer (INVENT® R, Bruker) as 1-R where R is the total reflectance that accounts for both specular and diffuse components. Near Infrared emissivity was measured between magnetic field on and off in the range 4000-1500 cm⁻¹.

Suspensions of magneto-responsive Janus colloids form chains and undergo alignment under the influence of a magnetic field. When the magnetic field is aligned with a light path, light transmission through the sample increases as compared to randomly or orthogonally oriented chains. The emissivity response of this suspension is presented as a function of particle concentration and magnetic field strength. A variation of the Beer-Lambert model and ray-tracing simulations capture the behavior of the experimentally measured difference in intensity between magnetically activated and non-activated Brownian suspensions. Experiments demonstrate up to 25% contrast in transmission of visible light, which may be further optimized through materials selection. Similar experiments when these Janus particle chains are suspended in carbon tetrachloride, demonstrate an emissivity variation in the near infrared of ˜10%.

Methods to control emissivity, according to the present teachings can include applying an electromagnetically actuated field to an optical device having a plurality of particles, wherein each of the particles comprise at least two surface characteristics, one of which is ferromagnetic, controlling alignment of the plurality of particles depending upon the applied electromagnetically actuated field, and measuring an emissivity reflected by the device with a pyroelectric detector. The emissivity reflected by the device can be decreased when the plurality of particles are aligned. The method can further include removing the electromagnetically actuated field from the optical device. Measuring emissivity can further include measuring total reflectance from the device.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An optical device, comprising:
a substrate;
a plurality of particles disposed in a layer on the substrate, wherein each of the plurality of particles comprises at least two surface characteristics, wherein the at least two surface characteristics each have distinct physical properties from one another;
a cover disposed over the plurality of particles; and
an electromagnetically actuated field in proximity to the layer of the plurality of particles.

2. The optical device of claim 1, wherein the substrate reflects in an infrared range.

3. The optical device of claim 1, wherein the substrate comprises a transparent material.

4. The optical device of claim 1, wherein the substrate further comprises a reservoir.

5. The optical device of claim 1, wherein the plurality of particles is suspended in a transparent fluid.

6. The optical device of claim 5, wherein the fluid comprises carbon tetrachloride, chloroform, water, isopropyl alcohol, or a combination thereof.

7. The optical device of claim 1, wherein the plurality of particles further comprise silica, polystyrene, polymethyl methacrylate, or a combination thereof.

8. The optical device of claim 5, wherein a concentration of the plurality of particles in the transparent fluid is a volume fraction from about 0.1 to about 1.5.

9. The optical device of claim 1, wherein the plurality of particles is from about 100 nm to about 50 microns.

10. The optical device of claim 1, wherein the plurality of particles further comprises a ferromagnetic coating on a portion of the surface of each of the plurality of particles.

11. The optical device of claim 10, wherein the ferromagnetic coating has a thickness of from about 25 nm to about 150 nm.

12. The optical device of claim 1, further comprising a detector configured to measure radiation emitted through the cover, and wherein the detector comprises a charge-coupled device (CCD) camera detector, a photospectrometer, a pryoelectric detector, or a combination thereof.

13. The optical device of claim 1, wherein the cover further comprises an infrared transparent material.

14. The optical device of claim 1, wherein the electromagnetically actuated field is generated by a magnet, a Helmholtz coil, or a combination thereof.

15. An optical device, comprising:
a substrate comprising a reservoir;
a suspension of a plurality of particles in an infrared transparent fluid, comprising a ferromagnetic coating on a portion of a surface of each of the plurality of particles, wherein the suspension is disposed in a layer on the substrate;
an infrared transparent cover disposed over the plurality of particles;
an electromagnetically actuated field in proximity to the layer of the plurality of particles; and
a detector in proximity to the cover to measure emissivity.

16. The optical device of claim 15, wherein:
the plurality of particles further comprise silica;
the infrared transparent fluid comprises isopropanol; and
the plurality of particles in the infrared transparent fluid is a volume fraction from about 0.1 to about 1.5.

17. A method to control emissivity, comprising:
applying an electromagnetically actuated field to an optical device having a plurality of particles, wherein each of the particles comprise at least two surface characteristics, one of which is ferromagnetic;
controlling alignment of the plurality of particles depending upon the applied electromagnetically actuated field; and
measuring emissivity reflected by the device with a pyroelectric detector.

18. The method of claim 17, wherein the emissivity reflected by the device is decreased when the plurality of particles are aligned.

19. The method of claim 17, wherein measuring emissivity further comprises measuring total reflectance.

20. The method of claim 17, wherein:
the plurality of particles further comprise silica, polystyrene, polymethyl methacrylate, or a combination thereof; and
the plurality of particles are suspended in an infrared transparent fluid; and
the infrared transparent fluid comprises carbon tetrachloride, chloroform, water, isopropyl alcohol, or a combination thereof.
